(19) United States
(12) Patent Application Publication
(10) Pub. No.: US 2003/0032408 A1
(43) Pub. Date: Feb. 13, 2003

(54) Data logging system and method

(75) Inventor: John Jennings, Berkshire (GB)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/216,959

(22) Filed: Aug. 12, 2002

(30) Foreign Application Priority Data
Aug. 13, 2001 (GB) 0119699.7

(51) Int. Cl. H04M 11/10

(52) U.S. Cl. 455/412; 455/558

(57) ABSTRACT

A method of logging operating data of mobile telephones comprises the steps of: producing an operating data message within a logging function at the mobile telephone; passing the operating data message to a radio unit within the telephone; transmitting the operating data message via the radio link to the mobile telephone network; receiving the operating data message at the network and passing this to a logging center; and logging the operating data at the logging center.

### BACKGROUND OF THE INVENTION

1. Field of the Invention

The present invention relates to mobile telephone handsets such as portable telephone apparatuses, and particularly to the logging of errors in the handsets.

2. Description of the Related Arts

The correct operation of a mobile telephone handset requires a number of components to operate correctly to enable transmission and reception of voice and other data. The main such functional components of a GSM (Global System for Mobile communications) mobile telephone are shown in FIG. 1.

A speaker 2, microphone 4, keypad 6, memory 8 and radio unit 10 are connected to a main processor 12. A SIM (Subscriber Identity Module) 14 is detachably connected to the processor 12.

The speaker 2, microphone 4 and keypad 6 allow a user to listen and speak, and to input numbers and text. The main processor 12 encompasses the functions of converting speech to digital data as well as operating other functions of the handset. The processor 12 cooperates with the memory 8 which stores the software executed by the processor 12 as well as data. The radio unit 10 transmits and receives the voice and other data.

The SIM 14 is a card comprising a processor 16 and memory 18. The SIM 14 store subscriber information as well as data such as names and addresses. The SIM processor 16 can execute software to control various aspects of the handset's functions.

The software resident in a mobile handset, whether in memory 12 or SIM memory 18, requires testing to ensure correct operation. However, the integration of GSM handsets into different cellular networks and geographical locations is often problematic, as each contain their own idiosyncrasies that cannot be easily predicted, or simulated, within the benign environment of the laboratory. Typically, problems encountered within the field result in engineers having to visit the location in order to recreate conditions and log diagnostic information locally. This adds expensive delays to problem resolution, especially if diagnostic tests have to be repeated and/or test builds downloaded.

We have appreciated that operation errors in mobile telephone handsets should be logged in an efficient manner.

### SUMMARY OF THE INVENTION

In a broad aspect the invention provides a method of logging operation errors in a mobile telephone handset by transmitting error messages from the handset over a radio link.

According to another aspect of the present invention, the invention provides a method of logging operating data of mobile telephones in a system in which a mobile telephone handset communicates with a network via a radio link, wherein the method comprises steps of: producing an operating data message within a logging function at the mobile telephone; passing the operating data message to a radio unit within the telephone; transmitting the operating data message via the radio link to the mobile telephone network; receiving the operating data message at the network and passing this to a logging center; and logging the operating data at the logging center.

According to further aspect of the present invention, the invention provides a mobile telephone adapted to produce operating data messages in which the mobile telephone communicates with a network via a radio link, wherein the mobile telephone comprises: a radio unit for transmitting and receiving data to and from the network; a logging function means for deriving operating data messages indicating data relating to operation of the mobile telephone and for passing the error messages to the radio unit for transmission.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a functional diagram of the main components of a mobile telephone handset;

FIG. 2 is a functional diagram of the pertinent components of a GSM handset embodying the invention; and

FIG. 3 is a state diagram of the logging process.

### DETAILED DESCRIPTION OF AN EMBODIMENT

The embodiment of the invention comprises at least one mobile telephone handset operating within a mobile telephone network, and a logging function associated with the network. The mobile telephone handset 1 is typically a GSM mobile telephone handset. In practice, a plurality of such handsets 1 will be configured according to the invention to allow errors from a larger sample of handsets to be logged.

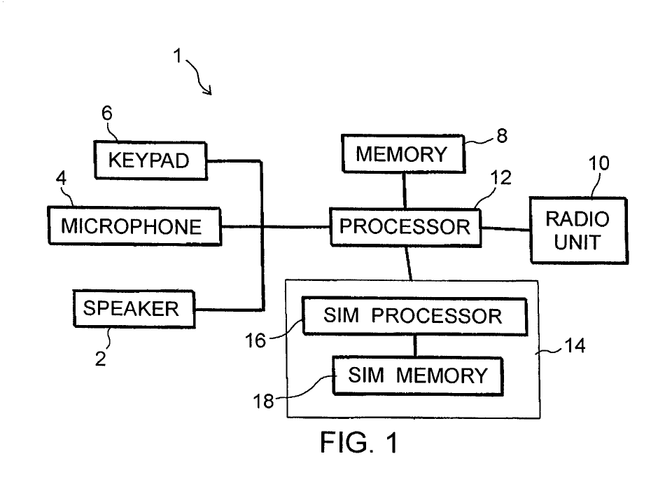

A mobile telephone handset embodying the present invention comprises the functional components shown in FIG. 1, but modified by additional software to provide logging functionality. As before, the mobile telephone 1 comprises input devices such as a keypad 6, microphone 4 and a loudspeaker 2 which communicate with a processor 12 to control the functions of the telephone in cooperation with a memory 8. The SIM card 14 includes both a SIM processor 16 which can execute software, and a SIM memory 18. Lastly, the handset communicates with a network through a radio unit 10 which handles transmission and reception of voice data and other data to and from the network. Such handsets are well known to the skilled person.

The operation of the handset requires correct function of both the hardware components and also the software executed either by the processor 12 or SIM processor 16. Any error in software or hardware can lead to an “exception” in the software. An exception is any abnormal behavior in a routine or subroutine, such as buffer overflows, resets or other problems. In addition to such abnormal behavior, the normal operation of a mobile telephone handset produces data relating to the functioning of hardware and software. Such error data and data relating to the normal operation are together termed operating data.

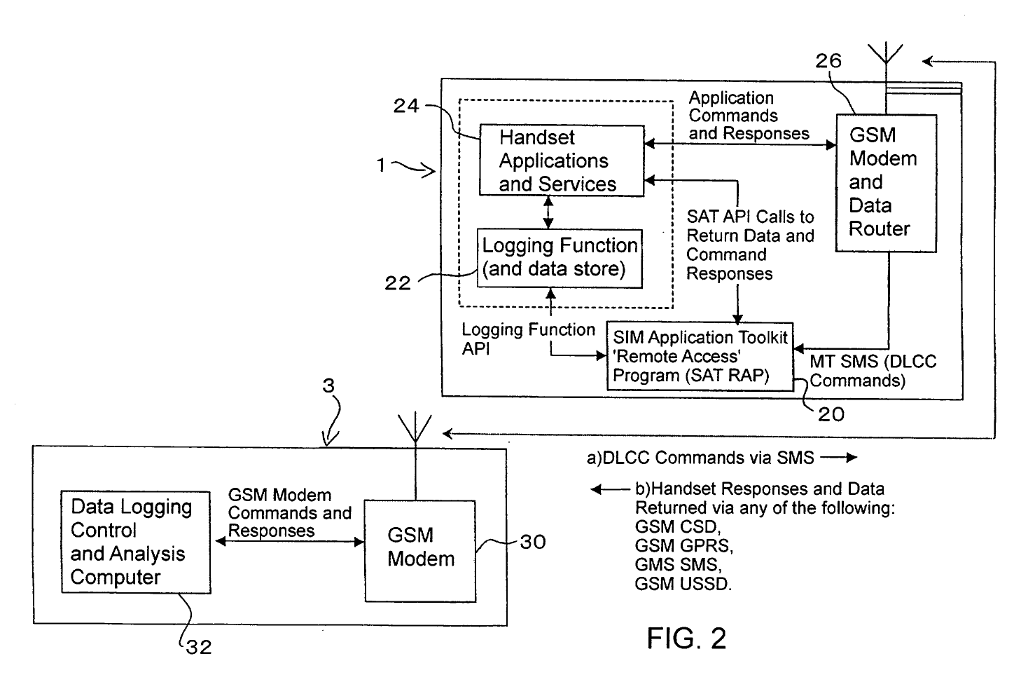

As previously noted, exceptions are currently manually recorded (logged) by test users who then file reports of the logged exceptions. The present embodiment avoids the need for manual logging and testing as shown by the functionality of the embodiment shown in FIG. 2.

The mobile telephone 1 comprises the same physical components as previously described, but modified to perform the functions shown in FIG. 2. A SIM Application Toolkit (SAT) program 20 provides the functionality to configure the telephone to extract error messages and other operating data from the applications within the handset. The SIM Toolkit is a programming application provided in the SIM of mobile telephone handsets to allow programs to be added, and is known to the skilled person. Of course, the SAT program 20 could equally be executed on the telephone's main processor 12. In either case, the program provides the function of configuring the telephone. The SAT “Remote Access” Program (SAT RAP) 20 is either pre-programmed into each handset's proactive SIM prior to releasing for test, or alternatively, the SAT RAP program could be downloaded to a proactive SIM containing a generic execution environment, e.g. Java virtual machine (MEXE). The latter has the flexibility to download diagnostic programs that are aligned to specific types of problem e.g. all handsets would initially be downloaded with a standard monitoring program.

To extract an error, or exception or other operating data, the SAT program 20 provides configuration commands to the logging function and data store 22. This is resident either in the main memory 8 and processor 12, or the SIM memory 18 and SIM processor 16. The logging function block 22 both identifies and stores errors occurring within the handset, and passes these to the SAT program 20.

The logging function 22 of the handset 1 monitors configurable error threshold levels, and will conditionally report to the SAT program 20 when exceeded. This in turn sends an alert message to the telephone network. Phones could be left unattended and controlled remotely using these techniques, or alternatively they could be used normally and logs returned via the designated bearer as and when logging triggers are generated, e.g. resets.

The mobile telephone embodying the present invention also comprises handset applications and services 24 which are the usual programs provided on processor 12. Also, a GSM modem and data router are part of the radio unit 10 and are known.

The errors and other operating data identified by the logging function and data store 22 are passed via the handset applications and services 24 to the GSM modem and data router 26 which transmits them to a data logging and control center (DLCC) 3. The data may be transmitted by any of a number of protocols, such as SMS (short message service), CSD (circuit switched data), GPRS (general packet radio service) or USSD (unstructured supplementary service data). Whilst any such protocol may be used, SMS is preferred.

The data logging control center (DLCC) 3 may be a part of the mobile telephone network, or a separate item. Such DLCCs are known to the skilled person, and a standard such DLCC could be used. The DLCC 3 comprises a known GSM modem 30 for receiving the error data signals, and a data logging and control analysis computer 32. The data logging control center 3 is a computer based host responsible for performing the logging activity. Typically, there is only one DLCC 3 per system, but for large handset trials it would be possible to configure a central DLCC responsible for acquiring results from many localized DLCCs. The Internet would be an ideal communication medium for, interconnected DLCCs.

The main responsibility of the DLCC is to encode diagnostic commands and submit them to the GSM modem for subsequent transmission to the designated remote handset (via the specified SMS Service Center) It also receives and decodes, solicited and unsolicited datagrams from any one of the available handsets. The DLCC then store them in the relevant handsets database, having performed any associated commands.

A DLCC can operate in one of four modes of operation:

1. Configuration Mode—allows operators to enter new handset addresses, purge handset logs, configure error alerting thresholds, and setup reporting email addresses.

2. Manual Mode—allows operators to interrogate and configure remote handsets on an individual basis manually.

3. Automatic Mode—requires minimal operator interaction, reliant upon preconfigured behavior to set up and acquire data from remote handsets. In this mode the DLCC is preprogrammed with a number of handset addresses that it is responsible for. Dependent upon it preprogrammed behavior the DLCC can perform combinations of the following by issuing configuration messages on a per handset basis:

periodically poll the handsets for information,

handsets reporting a particular problem could be automatically downloaded additional data to further quantify or fix the problem,

log interactive dialogues with handsets,

inform relevant engineers of pending problems, e.g. by e-mail,

control handset logging behavior,

control handset application behavior.

4. Diagnostic Mode—this is a variant of the manual mode of operation, allowing operators to diagnose problems within the DLCC software and/or associated handset SAT application.

The data logging and control analysis computer 32 can thus issue commands or configuration messages individually to each handset via SMS, and receive updates of logging data as a result. In particular, commands available to the DLCC 3 from the SAT program 20 include the following:

1. Activate Remote Logging,

2. Deactivate Remote Logging,

3. Request Log,

4. Request Status.

When handsets are first powered up they will either inform the DLCC 3 (via SMS) that they were operational, or alternatively the user could select a SAT RAP menu item to either activate or deactivate the logging function.

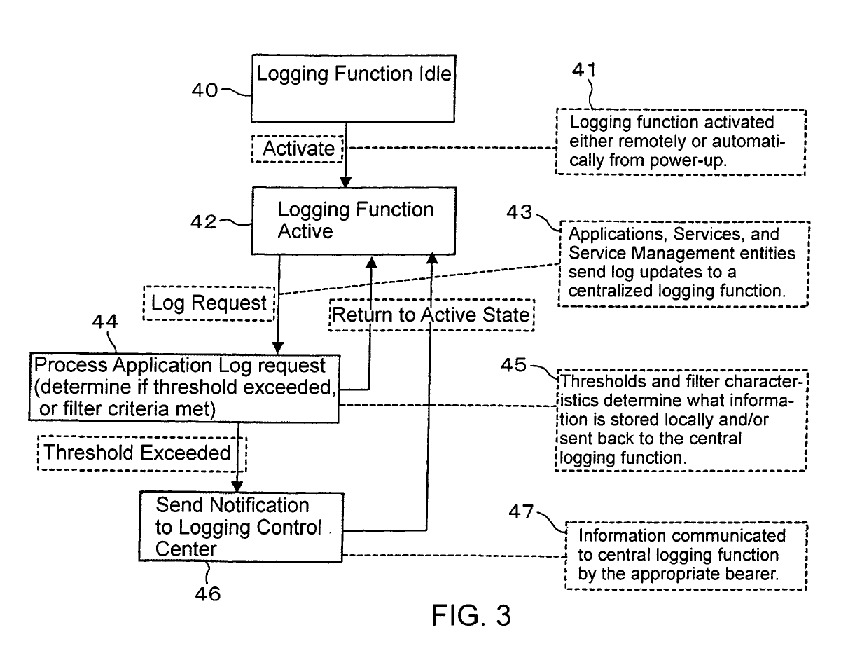

The logging states of a handset embodying the invention are shown in FIG. 3. First, in an idle state 40, the logging function 22 is idle. At box 41, the logging function is activated, either by a remote command over SMS from the DLCC 3, or automatically on power up. The logging function is then in an active state 42. Any exceptions are then extracted and stored by the logging function 22 at box 43. The logging function processes log requests at box 44, and determines whether a threshold is exceeded at box 45. If so, then notification is sent to the logging control center at box, 46. Otherwise, the logs are stored and sent at a later time 47 to the control logging function.

Once errors have been logged, they can be processed to determine the faults which allows a number of problems to be solved. The types of handset problems suitable to this approach include the following:

1. Algorithm Optimization—parameters could be optimized or changed, i.e. the SAT RAP program could apply new algorithm parameters under instruction from the DLCC.

2. Hardware Optimization—settings could be varied to find optimal values.

3. Application Bugs—program “patches” could be downloaded.

4. User settings could be modified to assist problem diagnosis.

5. Worst case scenarios could be configured to ascertain margin levels.

6. Certain types of intermittent problems traced.

In summary the embodiment provides a relatively non-intrusive technique, whereby it is possible to remotely:

acquire diagnostic information without the intervention of engineers on site,

adapt the handset software to further qualify the underlying problem, or

correct the problem completely.

The proposed system employs the GSM SMS service to relay commands from a central control center 3 to a remote SIM Application Toolkit (SAT) program 20 resident within the handset(s) under test. The SAT program will subsequently interact with the handset's software in accordance with the remote control center's instructions to configure logging options or acquire logging data.

The data bearers available to the SAT program for returning information to the control center include GSM SMS, GSM Circuit Switched Data, and eventually GSM GPRS.

There is a choice of transmission route for the commands to and from the handset, which are within the scope of the invention. The issues for the choice are:

a) Down-link data path—

Issuing logging and diagnostic commands,

Downloading new configuration data,

Downloading new program data.

b) Up-link data path—

Returning error logs,

Returning diagnostic data,

Returning command status.

The choice of data bearer depends on the following criteria:—

1. How intrusive the remote logging and diagnostics is to the application and user.

2. The availability of the bearer to the serving network or geographical location.

3. Required bandwidth, probably different for up-link and down-link.

4. Cost.

Now, potential data bearers are described as follows:

(1) SMS Bearer (low bandwidth):

Logging configuration via SMS-PP (point-to-point), i.e. items to be logged, bust logging, continuous logging,

Logging activation via SMS-PP and precondition, i.e., voice call set-up could be initiated prior to logging,

Data logs returned as SMS-PP msgs.

(2) GPRS Bearer (medium/high bandwidth):

Configured using MT (mobile terminal) SMS-PP and/or GPRS MT call.

Much higher bandwidth than option (1).

Relatively non-intrusive i.e. other phone activities can run in parallel.

Data logs returned in IP (Internet protocol) data packets.

(3) CSD Bearer (medium/high bandwidth):

Higher bandwidth than (1) but more intrusive for continuous logging.

more suited to burst logging.

Data logs returned as unstructured data blocks.

(4) USSD Bearer (medium bandwidth):

Logging configured as option (1),

Logged data returned using USSD bearer,

Potentially a better solution than (1).

Data logs returned as USSD blocks.

While a preferred embodiment of the present invention has been described using specific terms, such description is for illustrative purposes only, and it is to be understood that changes and variations may be made without departing from the spirit or scope of the following claims.

What is claimed is:

1. A method of logging operating data of mobile telephones in a system in which a mobile telephone handset communicates with a network via a radio link, said method comprising steps of:
producing an operating data message within a logging function at the mobile telephone;
passing the operating data message to a radio unit within the telephone;
transmitting the operating data message via the radio link to the mobile telephone network;
receiving the operating data message at the network and passing this to a logging center; and
logging the operating data at the logging center.

2. The method according to claim 1, further comprising a step of transmitting configuration messages from the logging center to the logging function within the telephone to configure the logging function.

3. The method according to claim 2, wherein the configuration messages cause the logging function to vary an aspect of operation for which operating data messages are produced.

4. The method according to claim 2, wherein the configuration messages cause the logging function to produce operating data messages depending upon previous operation of the telephone.

5. The method according to claim 1, further comprising a step of transmitting to the mobile telephone, configuration messages to vary operation of the telephone.

6. The method according to claim 2, further comprising a step of transmitting to the mobile telephone, further configuration messages to vary operation of the telephone.

7. The method according to claim 1, wherein the transmitting step is configurable so that the messages are sent periodically, on demand by the logging center or on reading a given threshold.

8. The method according to claim 2, wherein the step of transmitting the operating data message is configurable so that the messages are sent periodically, on demand by the logging center or on reading a given threshold.

9. The method according to claim 1, wherein the operating data massages are error messages.

10. A mobile telephone adapted to produce operating data messages in which the mobile telephone communicates with a network via a radio link, said mobile telephone comprising:
a radio unit for transmitting and receiving data to and from the network;
a logging function means for deriving operating data messages indicating data relating to operation of the mobile telephone and for passing the error messages to the radio unit for transmission.

11. The mobile telephone according to claim 10, further comprising a command reception function means configured to receive command messages from the logging center to pass them to the logging function within the telephone to configure the logging function.

12. The mobile telephone according to claim 11, wherein the logging function means is configurable by the configuration messages to vary an aspect of operation for which operating data messages are produced.

13. The mobile telephone according to claim 11, wherein the logging function means is configurable by the configuration message to produce operating data messages depending upon previous operation of the telephone.

14. The mobile telephone according to claim 11, wherein the logging function means is configurable by the configuration message to vary an aspect of operation for which operating data messages are produced and to produce the operating data messages depending upon previous operation of the telephone.

15. The mobile telephone according to claim 11, wherein the command reception function means is operable to receive configuration messages and to vary operation of the telephone.

16. The mobile telephone according to claim 10, wherein logging function means is configurable so that the operating data messages are sent periodically, on demand by the logging center or on reading a given threshold.

17. The mobile telephone according to claim 10, wherein the radio unit is configured to transmit the error messages as SMS messages.

18. The mobile telephone according to claim 10, wherein the operating data messages are error messages.
